(19) United States
(12) Patent Application Publication
(10) Pub. No.: US 2012/0139279 A1
(43) Pub. Date: Jun. 7, 2012

(54) STORAGE UNIT WITH CUP HOLDER AND STORAGE TRAY THAT SUPPORTS A DIGITAL MEDIA PLAYER

(76) Inventor: Okunzuwa Uwague-Igharo, Hilliard, OH (US)

(21) Appl. No.: 12/959,420

(22) Filed: Dec. 3, 2010

(51) Int. Cl. B60R 11/02

(52) U.S. Cl. 296/37.8

(57) ABSTRACT

A one piece storage unit may include a cup holder and a storage tray that is suitable to hold a digital media player in an upright position.

### BACKGROUND

1. Field of Invention

This invention generally relates to methods and apparatuses concerning storage units and more specifically relates to methods and apparatuses concerning a one piece storage unit that includes a cup holder and a storage tray that is suitable to hold a digital media player in an upright position.

2. Description of the Related Art

In recent years the popularity of digital media players (DMPs), including IPods and MP3 players, has increased dramatically. DMPs, depending on the particular type and model, may be used to store music files, video files, photos, podcasts and other such digital media files. One difficulty with DMPs is providing an appropriate place to support them when they are being used.

In the automotive industry storage space is limited so accommodating DMPs is especially difficult. It is known to place DMPs loosely in existing vehicle storage compartments such as trays and cup holders. The problem with many vehicle storage compartments, however, is that they do not hold the DMPS in an upright position (the position where DMPs are most easily used) and they do not secure the DMPs—making it easy for them to slide around as the vehicle is operated. The storage compartments that do hold DMPs in an upright position generally have little storage capacity beyond that for a DMP.

It is also known to place DMP holding inserts within cup holders. Such inserts, however, cause problems of their own. One problem is that the inserts add cost for the DMP user. Another problem is that they must be removed from the cup holder before the cup holder can be used to support a beverage container. Once removed, the inserts must then be stored somewhere in the vehicle—complicating the limited storage space.

What is needed, then, is a one piece storage unit that includes at least one cup holder and a storage tray that can be used to store various items but that also has a slot for use in supporting a DMP in an upright position.

### SUMMARY

According to one embodiment of this invention, an apparatus may comprise a one piece storage unit comprising: a first cup holder comprising a support surface for use in supporting an associated beverage container; a storage tray comprising a support surface for use in supporting associated items; and, a slot formed in the support surface of the storage tray for use in supporting in an upright position an associated digital media player.

According to another embodiment of this invention, an apparatus may comprise a vehicle component that is accessible within the passenger compartment of an associated vehicle; and, a one piece storage unit mounted to the vehicle component. The one piece storage unit may comprise: a first cup holder comprising a support surface for use in supporting an associated beverage container; a storage tray comprising a support surface for use in supporting associated items; and, a slot formed in the support surface of the storage tray for use in supporting in an upright position an associated digital media player.

According to yet another embodiment of this invention, an apparatus may comprise an armrest having a top surface that is suitable to support at least a portion of an associated person's arm; and a cavity that extends to the top surface; a digital media player docking station attached to the armrest and for use in connecting an associated digital media player to an associated sound system; and, a one piece storage unit mounted within the cavity in the armrest. The one piece storage unit may comprise: a first cup holder comprising a support surface for use in supporting an associated beverage container, wherein the first cup holder is accessible from the top surface of the armrest; a storage tray comprising a support surface for use in supporting associated items, wherein the storage tray is accessible from the top surface of the armrest; and, a slot formed in the support surface of the storage tray. The associated digital media player may be connectable to the digital media player docking station through the slot.

One advantage of this invention is that a storage unit can include a storage tray that can be used to store miscellaneous items or to support a DMP in an upright position.

Another advantage of this invention is that a storage unit can include one or more cup holders as well as a storage tray.

Yet another advantage of this invention is that DMPs can be supported without the use of inserts.

Other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective right side view of a vehicle.

FIG. 2 is perspective frontward facing view of the passenger compartment of the vehicle depicted in FIG. 1.

FIG. 3 is perspective backward facing view of the passenger compartment of the vehicle depicted in FIG. 1.

FIG. 4 is top perspective view of a storage unit mounted to a vehicle component.

FIG. 5 is top view of a storage unit mounted to an armrest.

FIG. 6 is a sectional view taken along line 6-6 of FIG. 5.

FIG. 7 is a close up sectional view similar to that shown in FIG. 6 except showing a DMP in an upright position at an upright angle UA.

### DETAILED DESCRIPTION

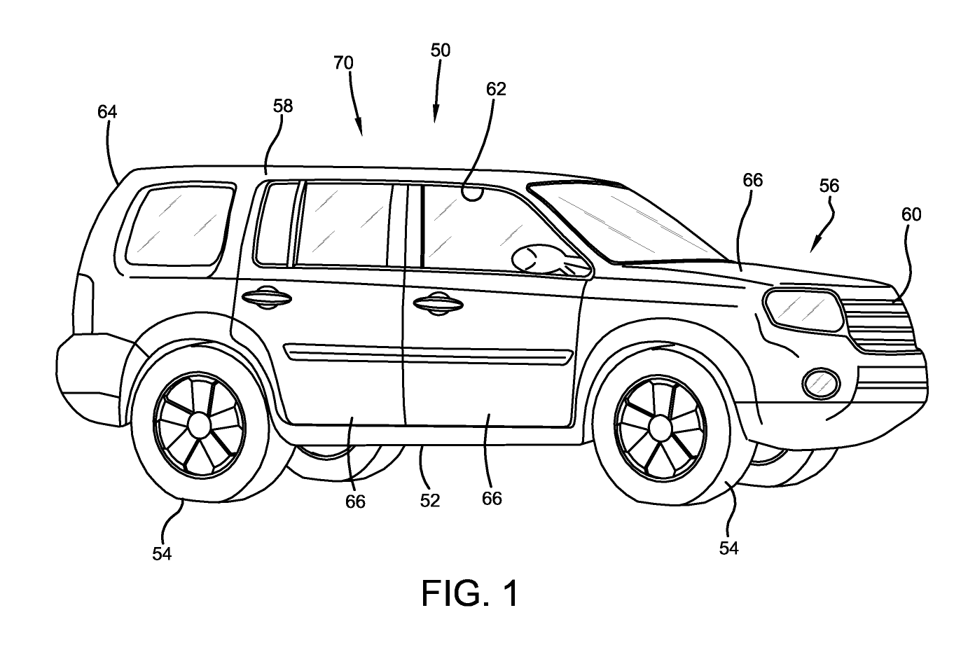

Referring now to the drawings wherein the showings are for purposes of illustrating embodiments of the invention only and not for purposes of limiting the same, and wherein like reference numerals are understood to refer to like components, FIG. 1 shows a vehicle 50 that may be equipped with one or more storage units 100 according to this invention. While the vehicle 50 shown is an SUV (Sports Utility Vehicle), it is to be understood that the storage unit 100 of this invention will work with any vehicle chosen with the sound judgment of a person of skill in the art, including vans, sedans, off-road vehicles, airplanes and boats and may have non-vehicle applications as well. The vehicle 50 may include a frame 52, one or more ground engaging wheels 54 mounted to the frame 52, and a locomotion source 56, such as an engine or motor, mounted to the frame 52, for use in providing locomotion for the vehicle 50. The vehicle 50 may also have a body 58 mounted to the frame 52 that defines one or more compartments. The body may define, for some non-limiting examples, a locomotion compartment 60 that houses the locomotion source 56, a passenger compartment 62 that houses one or more passengers, and a luggage compartment 64 that may be used to house luggage or other cargo. The vehicle 50 may also have doors 66 that are moveable with respect to the body 58 between open positions granting access to the interior of the body (and thus providing access to one or more of the compartments 60, 62, 64) and closed positions preventing access to the interior of the body 58.

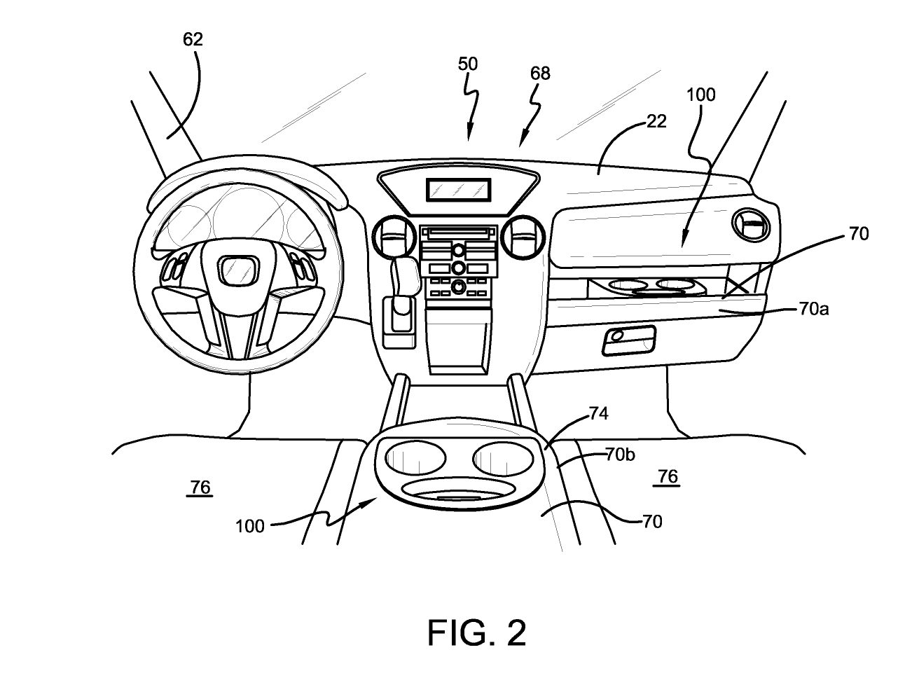

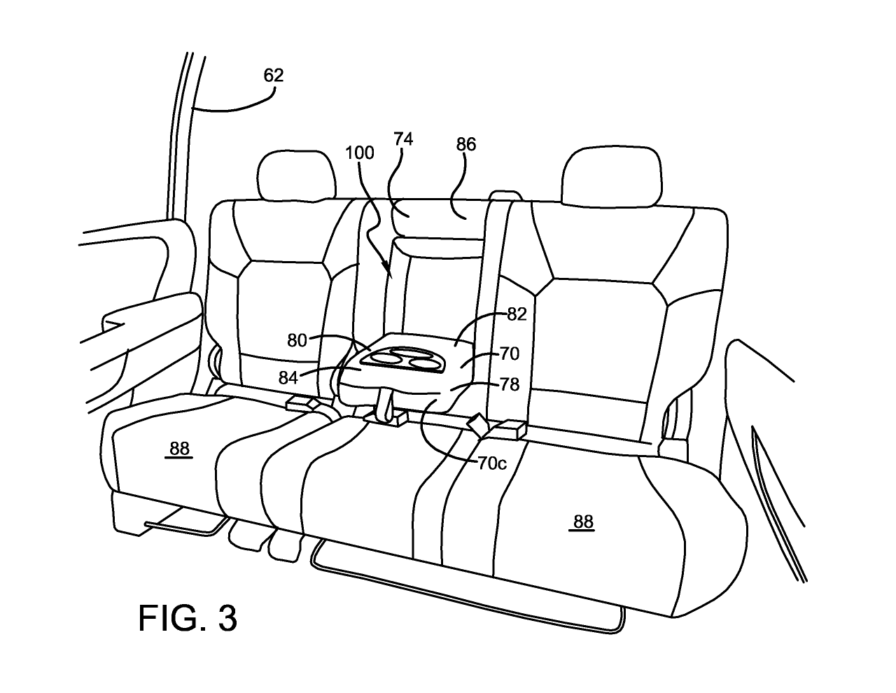

With reference now to FIGS. 1-3, the vehicle 50 may include one or more vehicle components 70, of any type, size and style chosen with the sound judgment of a person of skill in the art, that are accessible within the passenger compartment 62 and to which one or more storage units 100 may be mounted. Some non-limiting examples of such vehicle components 70 include: a vehicle component 70a, shown in FIG. 2, attached to the dashboard (also known as an instrument panel) 72 on the front end of the passenger compartment 62; a vehicle component 70b, also shown in FIG. 2, attached to the center console 74 between a pair of front seats 76, 76; and, a vehicle component 70c, shown in FIG. 3, that is an armrest 78. The vehicle 50 may also have a sound system 68 for uses well known to those of skill in the art.

With reference now to FIGS. 2-3, the armrest 78 may have a top surface 80 that is suitable to support a vehicle occupant's arm, as is well known in the art and a cavity 90 that extends to the top surface 80. In one embodiment, the armrest 78 has a first end 82 that is attachable to a structure and a second end 84. For the embodiment shown, the storage unit 100 is mounted within the cavity 90 at the second end 84 of the armrest 78 and the first end 82 of the armrest 78 is pivotally attached within the passenger compartment 62 to a seatback 86 between a pair of seats 88, 88 in a middle row of seats. If the storage unit 100 is mounted to an armrest 78, however, the armrest can be of any type. size, style, and location chosen with the sound judgment of a person of skill in the art. It should also be noted that the armrest does not have to be a vehicle component as the storage unit 100 can be mounted to other types of armrests.

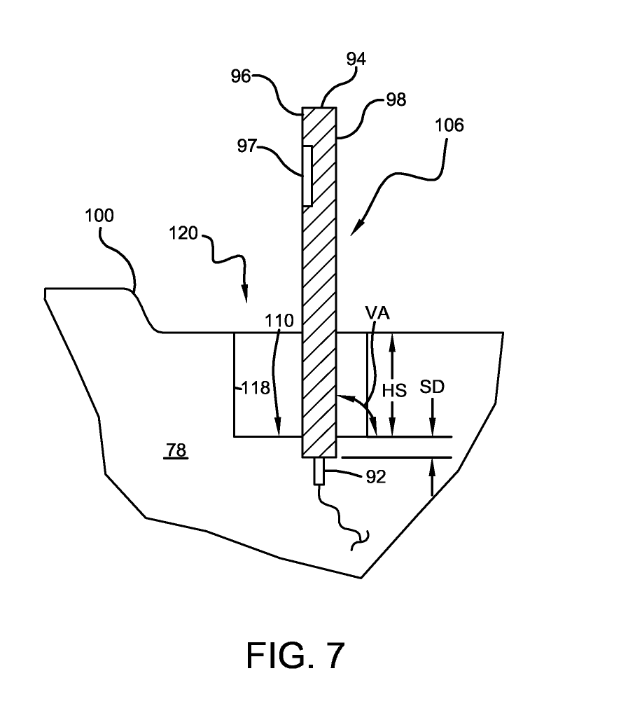

With reference now to FIG. 7, in one embodiment a digital media player docking station 92 is provided and may be used to connect a digital media player (DMP) 94 to the sound system 68 or for other uses (such as to charge the DMP 94). This invention will work with any DMP chosen with the sound judgment of a person of skill in the art. The DMP may have a front side 96 (the side that typically has a screen 97 that is used by the operator of the DMP as is well known to those of skill in the art) and a back side 98 (the side without the screen 97). In one specific embodiment, the digital media player docking station 92 is positioned within the armrest 78 and is accessible as will be discussed further below. As the structure and operation of DMPs and digital media player docking stations are well know to those of skill in the art, further details will not be provided here.

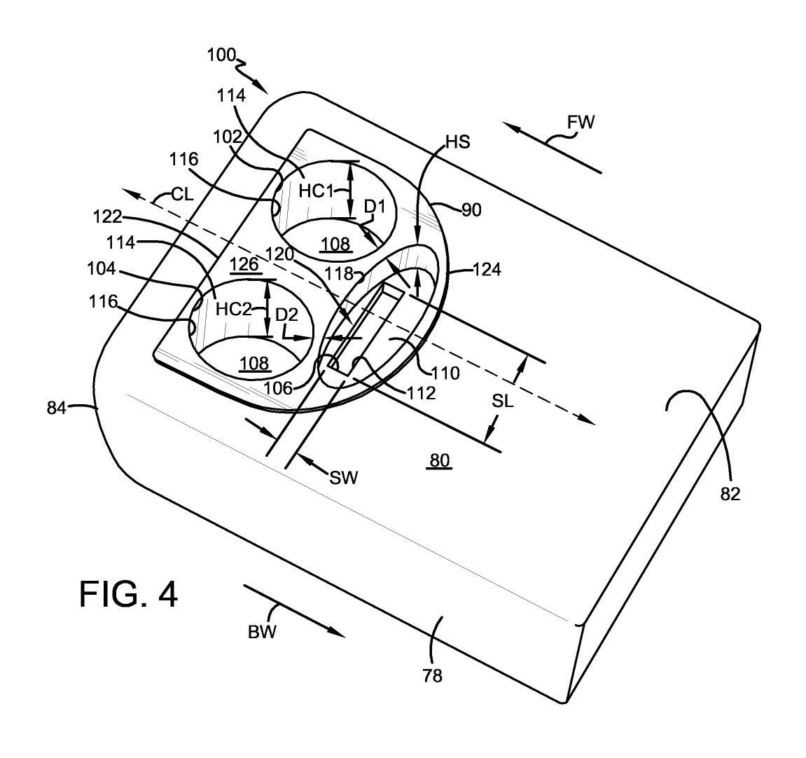

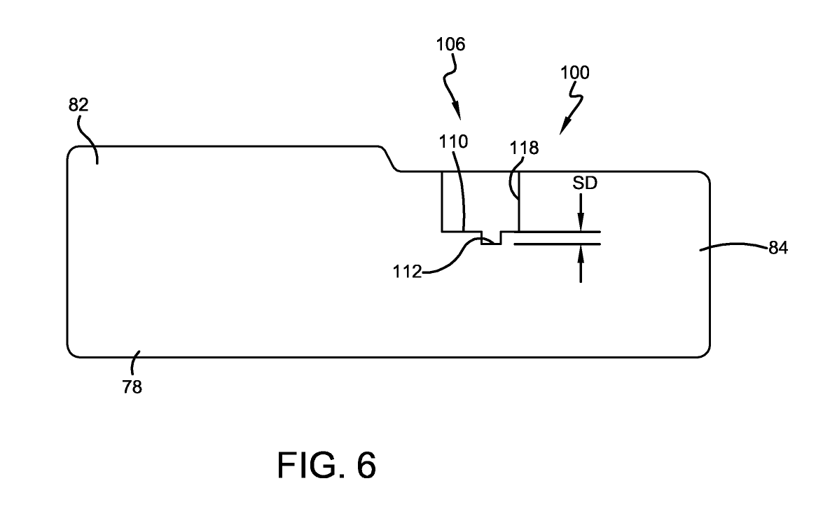

With reference now to FIGS. 4-7, the storage unit 100 may have a top surface 126 that, in one embodiment, is positioned coplanar with a corresponding component 70 surface. The storage unit 100 may be positioned, for example, with top surface 126 coplanar with the top surface 80 of the armrest 78. The storage unit 100 may also have at least one cup holder, two shown 102, 104 and a storage tray 106. Each cup holder 102, 104 may have a support surface 108 for use in supporting a beverage container (not shown) as is well known to those of skill in the art. The storage tray 106 may also have a support surface 110 for use in supporting items to be stored (including but not limited to snacks) as is also well known to those of skill in the art. In what follows the holding or supporting of a digital media player (DMP) in an upright position will be described. To assist in defining the expression “upright position” first the expression “upright angle” UA (labeled in FIG. 7) is defined as the angle between the back side 98 of the DMP 94 and the support surface 110. An upright position is defined as the position of the DMP where the upright angle UA is at least 30 degrees. In a more specific embodiment, the upright angle UA may be at least 45 degrees. In an even more specific embodiment, the upright angle UA may be at least 75 degrees. For the embodiment shown, the upright angle UA is 90 degrees.

With continuing reference to FIGS. 4-7, the storage tray 106 may also include a slot 112 formed in the support surface 110, as shown. The slot 112 may have a length

SL, a width SW and a depth SD sufficient to receive and support in an upright position a DMP. While the specific dimensions SL; SW and SD can be any chosen with the sound judgment of a person of skill in the art, in one embodiment, slot length SL is 2.75 inches, the slot width SW is 1.0 inches and the slot depth SD is 0.5 inches. While the slot 112 may also be positioned in any location on the support surface 110 chosen with the sound judgment of a person of skill in the art, for the embodiment shown the slot 112 is side-to-side centered on the support surface 110 and off center frontward, in direction FW. This position is ideal for viewing the screen 97 of the DMP 94 when it is positioned and supported within the slot 112.

With reference now to FIGS. 4 and 7, each cup holder 102, 104 may have a sidewall structure 114 that extends from the corresponding support surface 108 up to the top surface 126 and may define an opening 116 that receives beverage containers as is well known to those of skill in the art. The storage tray 106 may also have a sidewall structure 118 that extends from the corresponding support surface 110 up to the top surface 126 and may define an opening 120 that receives items to be stored, as is well known to those of skill in the art, and also receives

DMPs. The sidewall structures 114, 114 of the cup holders 102, 104 may have corresponding heights HC1, HC2 and the sidewall structure 118 of the storage tray 106 may have a height HS. Though these heights HC1, HC2 and HS may be any chosen with the sound judgment of a person of skill in the art, for the embodiment shown the heights HC1 and HC2 are the same and both are larger than height HS. While the shapes of the sidewall structures 114, 114, 118 can be of any shape chosen with the sound judgment of a person of skill in the art, for the embodiment shown the cup holder sidewall structures 114, 114 have a circular cross-section and the storage tray sidewall structures 118 has an elliptical cross-section.

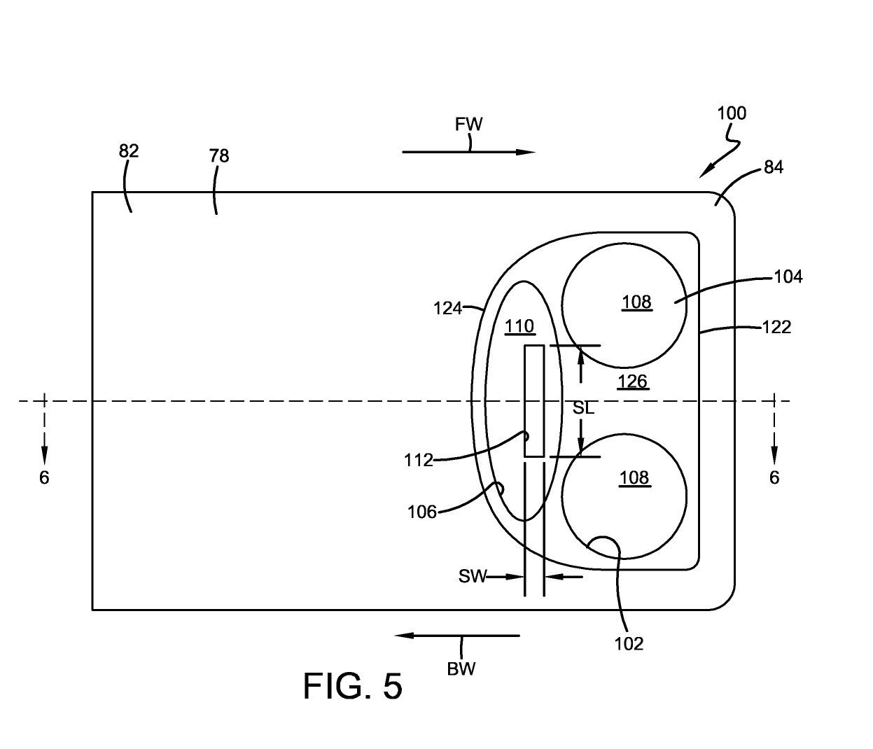

With reference now to FIGS. 4 and 5, the relative orientation of the cup holders 102, 104 and the storage tray 106 can be any chosen with the sound judgment of a person of skill in the art. For the embodiment shown, the cup holders 102, 104 are positioned relatively frontward, in direction FW, and the storage tray 106 is positioned relatively backward; in direction BW. For the embodiment shown, the cup holders 102, 104 are also positioned equidistant from a longitudinal centerline CL and the centerline CL bisects the storage tray 16 into two equal parts. To keep the storage unit 100 compact, in one embodiment the smallest distance D1 between the sidewall structure 114 of cup holder 102 and the sidewall structure 118 of the storage tray 106 may be 0.5 inches or less. Similarly, the smallest distance D2 between the sidewall structure 114 of cup holder 104 and the sidewall structure 118 of the storage tray 106 may be 0.5 inches or less.

With continuing reference to FIGS. 4 and 5, the shape of the storage unit 100 may also be any chosen with the sound judgment of a person of skill in the art. For the embodiment shown the relatively frontward wall 122 has a linear edge and the relatively backward wall 124 has a curved edge. To ease production and installation of the storage unit 100, it may be made as a single or one piece unit construction. By “one piece” it is meant a single part or component. In one non-limiting embodiment, the one piece storage unit 100 is made of plastic in an injection molding process. In a more specific embodiment, molten plastic may be injected into a single cavity mold to produce the one piece storage unit 100. It should be noted, however, that any method of forming a one piece storage unit 100 can be used with this invention.

With reference now to FIGS. 1-7, in one embodiment the storage unit 100 may be mounted to a vehicle component 70. In a specific embodiment, the storage unit 100 may be positioned within the cavity 90 formed in the armrest 78, as shown. If the armrest 78 is pivotal about its first end 82, it may be pivoted from a position where the storage tray 100 cannot be used (not shown) to a position where it can be used, see FIG. 3, and thus the cup holders 102, 104 and the storage tray 106 are accessible from the top surface 80 of the armrest 78. If a DMP 94 is not used, then various items can be easily stored on the support surface 110 of the storage tray 106. However, if a DMP 94 is to be used, it can be inserted within the slot 112 and held in an upright position. If a digital media player docking station 92 is used, it may be positioned so that the DMP 94 can connect to it through the slot 112 in the storage tray 106. As is well known to those of skill in the art, a digital media player docking station will hold a corresponding DMP in an upright position.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. An apparatus comprising:
a one piece storage unit comprising:
a first cup holder comprising a support surface for use in supporting an associated beverage container;
a storage tray comprising a support surface for use in supporting associated items; and,
a slot formed in the support surface of the storage tray for use in supporting in an upright position an associated digital media player.

2. The apparatus of claim 1 wherein the apparatus further comprises:
a digital media player docking station for use in connecting the associated digital media player to an associated sound system; and,
wherein the associated digital media player is connectable to the digital media player docking station through the slot.

3. The apparatus of claim 1 wherein:
the first cup holder comprises a sidewall structure that extends from the support surface of the first cup holder and defines an opening for use in receiving the associated beverage container; and,
the storage tray comprises a sidewall structure that extends from the support surface of the storage tray and defines an opening for use in receiving the associated digital media player;

4. The apparatus of claim 3 wherein:
the height HC1 of the sidewall structure of the first cup holder is larger than the height HS of the sidewall structure of the storage tray.

5. The apparatus of claim 3 wherein:
the sidewall structure of the first cup holder has a substantially circular cross-section; and,
the sidewall structure of the storage tray has a substantially elliptical cross-section.

6. The apparatus of claim 1 wherein:
the one piece storage unit is formed of plastic.

7. The apparatus of claim 1 wherein:
the one piece storage unit further comprises a second cup holder comprising a support surface for use in supporting an associated beverage container.

8. An apparatus comprising:
a vehicle component that is accessible within the passenger compartment of an associated vehicle; and,
a one piece storage unit mounted to the vehicle component, the one piece storage unit comprising:
a first cup holder comprising a support surface for use in supporting an associated beverage container;
a storage tray comprising a support surface for use in supporting associated items; and,
a slot formed in the support surface of the storage tray for use in supporting in an upright position an associated digital media player.

9. The apparatus of claim 8 wherein the apparatus further comprises:
a digital media player docking station for use in connecting the associated digital media player to an associated sound system; and,
wherein the associated digital media player is connectable to the digital media player docking station through the slot.

10. The apparatus of claim 8 wherein:
the first cup holder comprises a sidewall structure with a substantially circular cross-section that extends from the support surface of the first cup holder and defines an opening for use in receiving the associated beverage container; and,
the storage tray comprises a sidewall structure with a substantially elliptical cross-section that extends from the support surface of the storage tray and defines an opening for use in receiving the associated digital media player.

11. The apparatus of claim 8 wherein:
the vehicle component is attached to an associated dashboard on the front end of the passenger compartment of the associated vehicle.

12. The apparatus of claim 8 wherein:
the vehicle component is attached to an associated center console between a pair of associated front seats.

13. The apparatus of claim 8 wherein:
the vehicle component is an armrest having a top surface that is suitable to support at least a portion of an associated vehicle occupant's arm; and,
the one piece storage unit is mounted to the armrest with the first cup holder and the storage tray being accessible from the top surface of the armrest.

14. The apparatus of claim 8 wherein:
the one piece storage unit is formed of plastic; and,
the one piece storage unit further comprises a second cup holder comprising a support surface for use in supporting an associated beverage container.

15. An apparatus comprising:
an armrest comprising: a top surface that is suitable to support at least a portion of an associated person's arm; and a cavity that extends to the top surface;
a digital media player docking station attached to the armrest and for use in connecting an associated digital media player to an associated sound system;
a one piece storage unit mounted within the cavity in the armrest, the one piece storage unit comprising:
a first cup holder comprising a support surface for use in supporting an associated beverage container, wherein the first cup holder is accessible from the top surface of the armrest;
a storage tray comprising a support surface for use in supporting associated items, wherein the storage tray is accessible from the top surface of the armrest; and,
a slot formed in the support surface of the storage tray; and,
wherein the associated digital media player is connectable to the digital media player docking station through the slot.

16. The apparatus of claim 15 wherein:
the armrest comprises: a first end that is attachable to an associated structure, and, a second end; and,
the one piece storage unit is mounted at the second end of the armrest.

17. The apparatus of claim 16 wherein:
the first end of the armrest is pivotally attachable within a passenger compartment of an associated vehicle.

18. The apparatus of claim 15 wherein:
the first cup holder comprises a sidewall structure that extends from the support surface of the first cup holder and defines an opening for use in receiving the associated beverage container;
the storage tray comprises a sidewall structure with a substantially elliptical cross-section that extends from the support surface of the storage tray and defines an opening for use in receiving the associated digital media player;
the smallest distance D1 between the sidewall structure of the first cup holder and the sidewall structure of the storage tray is 0.5 inches or less.

19. The apparatus of claim 18 wherein:
the one piece storage unit further comprises a second cup holder comprising a support surface for use in supporting an associated beverage container, wherein the second cup holder: is accessible from the top surface of the armrest; and, comprises a sidewall structure that extends from the support surface of the second cup holder and defines an opening for use in receiving the associated beverage container; and,
the smallest distance D2 between the sidewall structure of the second cup holder and the sidewall structure of the storage tray is 0.5 inches or less.

20. The apparatus of claim 19 wherein:
the heights HC1 and HC2 of the sidewall structures of the first and second cup holders: are substantially the same; and, are each larger than the height HS of the sidewall structure of the storage tray;
the sidewall structures of the first and second cup holders each have a substantially circular cross-section; and,
the sidewall structure of the storage tray has a substantially elliptical cross-section.
